(19) United States
(12) Patent Application Publication
(10) Pub. No.: US 2016/0362647 A1
(43) Pub. Date: Dec. 15, 2016

(54) DOSAGE FORM FOR WASHING OR CLEANING AGENTS

(71) Applicant: Henkel AG & Co. KGaA, Duesseldorf (DE)

(72) Inventors: Georg Meine, Mettmann (DE); Christian Reichert, Weingarten (DE); Peter Schmiedel, Duesseldorf (DE); Bernd Larson, Erkelenz (DE); Cornelius Bessler, Duesseldorf (DE)

(73) Assignee: Henkel AG & Co. KGaA, Duesseldorf (DE)

(21) Appl. No.: 15/247,387

(22) Filed: Aug. 25, 2016

Related U.S. Application Data
(63) Continuation of application No. PCT/EP2015/056050, filed on Mar. 23, 2015.

(30) Foreign Application Priority Data
Mar. 31, 2014 (DE) 10 2014 004 533.1

(51) Int. Cl. C11D 17/04; C11D 3/386; C11D 3/22

(52) U.S. Cl. CPC C11D 17/043; C11D 3/222; C11D 3/386

(57) ABSTRACT

The invention relates to a molded foam body which comprises a dry foam and which is filled with a liquid washing or cleaning agent composition, to a set of molded foam bodies, to a method for producing said molded foam bodies, to a method for washing or cleaning and to the use of the molded foam bodies and the sets.

### FIELD OF THE INVENTION

The present invention generally relates to a molded foam body which comprises a dry foam and which is filled with a liquid washing or cleaning agent composition, to a set of molded foam bodies, to a method for producing the molded foam body, to a method for washing or cleaning and to the use of the molded foam body and the set.

### BACKGROUND OF THE INVENTION

To date, liquid washing or cleaning agent compositions have been sold in relatively heavy containers. Typically, the weight of a plastic bottle for holding 2 liters of a liquid washing agent is around 100 to 150 g. The liquid washing agent is usually portioned using dosing caps, whereby it may happen that the hands of the end user are wetted by the washing agent or the liquid washing agent drips onto the washing machine or next to the washing machine. The same applies to cleaning agents.

Another problem linked to the use of liquid washing agents is that bleaching agents have until now not been able to be incorporated. Due to contact with the other washing agent components, either the bleaching agent is used up before the time at which the consumer uses the washing or cleaning agent or else washing or cleaning agent components, such as enzyme constituents for example, are destroyed by the bleaching agent. Such liquid washing or cleaning agents are therefore inferior to corresponding solid washing or cleaning agents.

Problems also occur when the liquid washing or cleaning agents contain protease and other enzymes. This is because the protease contained therein breaks down during the storage time and in particular breaks down the other proteolytic enzymes. The use of reversible protease inhibitors admittedly solves this problem, but this is problematic due to the toxicology of the protease inhibitors and the fact that the latter are harmful to the environment.

DE 2204335 C2 describes a liquid propellant preparation. EP 1534811 B1 describes an extruded cleaning product. US 2011/0023240 A1 describes a textile washing agent. US 2011/0028373 A1 describes a hand care product. US 2011/0028374 A1 describes a washing agent composition. WO 2007/034471 A2 describes a film which contains washing agent. WO 97/34993 A1 describes a toilet cleaning agent. WO 2006/039264 A1 describes a multilayer film. WO 03/030881 A1 describes a film containing an active substance. US 2008/0260836 A1 describes films made from a plurality of polymers.

The object of the present invention is to provide a dosage form for liquid washing or cleaning agents, which dosage form is lightweight and easy to handle, so that no undesired mess is created during the dosing.

The aim is also to solve the other problems described above.

The present invention relates in a first aspect to a molded foam body, wherein the molded foam body comprises dry foam consisting of cells, wherein the material from which the walls of the foam cells are formed comprises one or more polysaccharides or foam sugars in a proportion of at least 10% by weight, preferably at least 40% by weight, based on the total weight of the material from which the cell walls of the dry foam are formed, wherein the molded foam body contains a liquid washing or cleaning agent composition in a proportion of at least 5% by weight, preferably at least 20% by weight, based on the total weight of the molded foam body, and wherein the liquid washing or cleaning agent composition is arranged within the cells of the dry foam of the molded foam body and, when the molded foam body comes into contact with water, the liquid washing or cleaning agent composition is released into the water, and wherein the material of the dry foam, particularly preferably of that of the entire molded foam body, can disintegrate in water and/or is water-soluble.

In a further aspect, the present invention relates to a set consisting of at least two molded foam bodies, as described herein, characterized in that the set comprises at least one first and at least one second molded foam body, wherein the dry foam of the at least one first molded foam body includes a liquid washing or cleaning agent composition which contains at least one first constituent, the concentration of which in the liquid washing or cleaning agent composition of the at least one first molded foam body is higher than in the liquid washing or cleaning agent composition that is located in the dry foam of the at least one second molded foam body, wherein preferably the at least one first constituent is incompatible with a constituent which is contained in the liquid washing or cleaning agent composition that is located in the dry foam of the at least one second molded foam body.

In a third aspect, the present invention relates to a method for producing a molded foam body, as described herein, characterized in that an unfilled molded foam body is provided which comprises dry foam consisting of cells, and cells of the dry foam are filled with at least one first liquid washing or cleaning agent composition, wherein preferably the filling takes place by injection, vacuum filling or compression with subsequent release, particularly preferably by means of injection.

In a fourth aspect, the present invention relates to a washing or cleaning method comprising the method steps:
i) providing a washing or cleaning solution comprising one or more molded foam bodies, as described herein, or one or more sets, as described herein,
ii) bringing a soiled object, preferably a soiled textile, in particular a soiled flat textile, or a soiled hard surface, in particular a soiled dish, into contact with the washing or cleaning solution according to (i), wherein preferably the method is carried out in a washing machine or an automatic dishwasher.

In a fifth aspect, the present invention relates to the use of a molded foam body, as described herein, or of a set, as described herein, for washing textiles or for cleaning hard surfaces, in particular for removing soil on textiles or hard surfaces, preferably in a washing machine or an automatic dishwasher.

The inventors have now surprisingly discovered that the problems described above can be solved by a particular molded foam body.

Furthermore, other desirable features and characteristics of the present invention will become apparent from the subsequent detailed description of the invention and the appended claims, taken in conjunction with this background of the invention.

### BRIEF SUMMARY OF THE INVENTION

A molded foam body, wherein the molded foam body comprises dry foam consisting of cells, wherein the material from which the walls of the foam cells are formed comprises one or more polysaccharides or foam sugars in a proportion of at least 10% by weight, preferably at least 40% by weight, based on the total weight of the material from which the cell walls of the dry foam are formed, the molded foam body contains a liquid washing or cleaning agent composition in a proportion of at least 5% by weight, preferably at least 20% by weight, based on the total weight of the molded foam body; and the liquid washing or cleaning agent composition is arranged within the cells of the dry foam of the molded foam body and, when the molded foam body comes into contact with water, the liquid washing or cleaning agent composition is released into the water; and wherein the material of the dry foam, particularly preferably of that of the entire molded foam body, can disintegrate in water and/or is water-soluble.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

The present invention relates in a first aspect to a molded foam body, wherein the molded foam body comprises dry foam consisting of cells, wherein the material from which the walls of the foam cells are formed comprises one or more polysaccharides or foam sugars in a proportion of at least 10% by weight, preferably at least 40% by weight, based on the total weight of the material from which the cell walls of the dry foam are formed, wherein the molded foam body contains a liquid washing or cleaning agent composition in a proportion of at least 5% by weight, preferably at least 20% by weight, based on the total weight of the molded foam body, and wherein the liquid washing or cleaning agent composition is arranged within the cells of the dry foam of the molded foam body and, when the molded foam body comes into contact with water, the liquid washing or cleaning agent composition is released into the water, and wherein the material of the dry foam, particularly preferably of that of the entire molded foam body, can disintegrate in water and/or is water-soluble.

This administration form makes it possible to combine liquid washing or cleaning agent compositions having different compositions in a single administration body, in this case a molded foam body. This administration form also solves the problem of combining incompatible constituents in a single administration body. Moreover, the administration form makes it possible to combine different administration bodies with one another, each of these including different liquid washing or cleaning agent compositions. The consumer also no longer has to handle the liquid washing or cleaning agent compositions, so that the use of the molded foam bodies enables clean and safe dosing. Furthermore, the molded foam bodies can be configured in an optically appealing and flexible manner, so that new designs which are appealing to the consumer are possible for washing or cleaning agents.

A molded foam body in the context of the present invention is an article which may include for example a unit dose of a washing or cleaning agent. The article is ready to use and can be used for washing or cleaning.

In the context of the present invention, the term “unit dose” relates to a physically isolated dose which contains a predetermined quantity of washing or cleaning agent in order to achieve a desired washing or cleaning effect.

The molded foam body has the dimensions customary for domestic washing or cleaning agents. In certain embodiments, the body has a volume of 200 mL or less, preferably 100 mL or less, more preferably 50 mL or less, even more preferably 25 mL or less, particularly preferably 10 mL or less, more preferably 5 mL or less, even more preferably 3 mL or less, yet more preferably 2 mL or less.

The term “released” means that, when the molded foam body comes into contact with water, the liquid washing or cleaning agent contained in the molded foam body passes into the water from the cells of the foam contained in the molded foam body. A washing or cleaning solution is thus formed, which is active for washing purposes and dissolves soil, for example on textiles or hard surfaces.

The term “disintegrable” means that the dry foam or molded foam body, upon contact with water at temperatures between 15 and 60° C. and in particular between 20 and 45° C., breaks down into small parts within 15 minutes, preferably 10 minutes.

In the context of the present invention, “water-soluble” means that a component has a solubility in distilled water, measured at 25° C., of approximately at least 0.1 g/L. In some embodiments, the components have a solubility of approximately at least 0.1 to approximately 500 g/L, measured at 25° C.

In connection with the molded foam body or the dry foam, “water-soluble” means that the constituents of the molded foam body or of the foam have a solubility in water, measured at 25° C., of approximately at least 0.1 g/L. In some embodiments, the constituents of the layer have a solubility of approximately at least 0.1 to approximately 500 g/L, measured at 25° C.

As used herein, “at least one” means 1 or more, for example 1, 2, 3, 4, 5, or more.

In this context, “liquid” means that the preparations in question are flowable liquids, pastes or gels. In addition, solid means that the preparations in question exist in solid form, in powder form or as granules.

Liquid washing or cleaning agents may thus exist in the form of solutions, gels, suspensions or dispersions.

Washing or cleaning agents usually have a viscosity of up to 100,000 mPas. This viscosity can be measured for example using a Brookfield—RVT viscometer at 25° C. and a suitable spindle.

In the present document, the term “foam” or “dry foam” will be understood to mean a structure consisting of spherical or polyhedral cells which are bounded by highly viscous or solid cell edges.

In certain embodiments, the dry foam has an average cell diameter of 10 to approximately 1200 μm, preferably 200 to approximately 1000 μm.

In particular embodiments, the dry foam is flexible.

In the context of the present invention, “flexible” means that the claimed layer reversibly assumes its original shape again after being deformed. This is the case in particular when the layer has a modulus of elasticity, determined at 25° C. by tension experiments, in the linear range of from 0.001 to 100 MPa, preferably from 0.01 to 10 MPa, in particular from 0.1 to 1 MPa. In particular, the foam of the at least one first layer has a modulus of elasticity, determined at 25° C. by tension experiments, in the linear range of from 0.001 to 100 MPa, preferably from 0.01 to 10 MPa, in particular from 0.1 to 1 MPa. The measurements are carried out using the device “TA.XTplus Texture Analyser” from the company Stable Micro Systems. Details can be found in the examples.

In the context of the present invention, the “average cell diameter” is determined as follows. The cross-section of a foamed section of a piece of foam was photographed using a microscope. Based on the photos, the average diameter of 10 to 20 cells is taken as the average cell diameter. In the event of doubt, in the case of irregularly shaped cells, always the longest possible diameter of a cell is ascertained and used for the calculation. Suitable software is, for example, the ImageJ program. ImageJ is a freely available program which allows Java-based image processing and was developed at the National Institutes of Health. The program is also suitable for determining the thickness of the cell walls. The pixel size of the digital camera and the magnification factor of the microscope must be used in order to calculate object sizes on the photos.

In certain embodiments, the dry foam of the at least one first layer has a density of from approximately 0.03 g/cm³ to approximately 0.40 g/cm³, in particular from approximately 0.05 g/cm³ to approximately 0.2 g/cm³, very particularly from approximately 0.05 g/cm³ to approximately 0.1 g/cm³. The density is determined by cutting out of a piece of foam a block having a size of 10 mm×100 mm×100 mm and weighing said block. This data relates to the foam without any washing or cleaning agent composition in the cells.

In the context of the present invention, the term “dry” means that the foam has a water content of 6% by weight or less before the washing or cleaning agent composition is introduced.

The term “polysaccharides” will be understood to mean sugars having a chain length of at least 3 sugar units. Particular preference is given to starch, cellulose, pectin, glycogen, hemicellulose and mixtures and derivative thereof. Starch and cellulose and derivatives thereof are particularly preferred. Examples of cellulose derivatives are cellulose ethers, carboxymethyl cellulose, hydroxyethyl cellulose and hydroxypropyl cellulose. Examples of starches are corn starch, wheat starch, rye starch, barley starch, potato starch, sweet potato starch and rice starch. The foam preferably comprises at least 50% by weight polysaccharide.

The term “foam sugar” refers to foamed single or double sugars. Here, the term sugar encompasses food sugars, such as for example glucose, fructose, mannose, invert sugar, maltose, sucrose and mixtures thereof. Foam sugar is produced by the methods known from the confectionery industry. Besides sugar, foam sugar also usually encompasses whipped egg white, gelling agent and optionally further constituents. The sugar content is at least 50% by weight.

Preferably, the molded foam body has a compressive strength of at least 30 g/cm². This compressive strength can be measured for example via customary test methods, but also via the following test method: 21 flips of molded foam body are distributed over a surface area of approximately 78.5 cm² and loaded with a weight of 2500 g. In certain embodiments, the number of molded foam body flips can be reduced to 3 without these collapsing and losing shape under the given pressure load. As long as the flips do not collapse or lose shape, they have the necessary compressive strength.

The specific surface area of the foam preferably lies in a range from 5 to 25 cm²/cm³, in particular in a range from 10 to 20 cm²/cm³.

In the present invention, the term “liquid washing or cleaning agent composition” refers to a composition which gives rise to an active washing solution in water. In this case, a single molded foam body which includes a “liquid washing or cleaning agent composition” need not contain all the constituents of a typical liquid washing or cleaning agent composition. This may be obtained in that two liquid washing or cleaning agent compositions, which in combination give rise to an active washing solution in water, are included in one molded foam body. An active washing solution can also be produced by combining two or more molded foam bodies which contain different liquid washing or cleaning agent compositions.

In particular embodiments, the molded foam body is characterized in that the density of the molded foam body filled with the liquid washing or cleaning agent composition lies in a range from 0.7 to 0.9 g/mL.

In different embodiments of the molded foam body according to the invention, the dry foam of the molded foam body has a layer which extends over the entire outer side of the dry foam and comprises at least the outermost 2 mm, particularly preferably at least the outermost 5 mm, of the dry foam of the molded foam body and is not filled with the liquid washing or cleaning agent composition.

The term “layer,” as used in the present invention, refers to a flat structure possessed by the molded foam body.

In some embodiments, the molded foam body contains at least 100% by weight, in particular at least 140% by weight, liquid washing or cleaning agent composition based on the weight of the dry foam, preferably based on the weight of the molded foam body.

In different embodiments of the molded foam body, the liquid washing or cleaning agent composition comprises 0.01 to 90% by weight, preferably 0.1 to 20% by weight, of at least one alkylbenzene sulphonate, preferably LAS, 0 to 10% by weight, preferably 0 to 5% by weight, of at least one enzyme, preferably selected from the group consisting of protease, cellulose, mannanase, hemicellulase, amylase, lipase and mixtures thereof, 0 to 90% by weight, preferably 0 to 20% by weight, of at least one non-ionic surfactant, preferably ethoxylated alcohols having 8 to 18 C atoms, 0 to 90% by weight, preferably 0 to 15% by weight, of fatty acid, preferably C8 to C20 fatty acid, 0 to 90% by weight, preferably 0 to 10% by weight, of bleaching agents and bleach activators, preferably bleaching agents, 0 to 90% by weight, preferably 0 to 25% by weight, of polymers and perfume oils and/or 0 to 90% by weight, preferably 0.5 to 50% by weight, of builder polymers, preferably CMC, based on the total weight of the respective washing or cleaning agent composition.

Bleaching agents and/or bleach activators may be contained in the washing or cleaning agent preferably in a quantity in a range from 0 to 90% by weight, in particular in a range from 1 to 30% by weight, based on the total weight of the washing or cleaning agent, preferably based on the total weight of the molded foam body.

In some embodiments, the washing or cleaning agent contains 1 to 25% by weight polymers and perfume oils.

In addition to the liquid washing or cleaning agent, solid washing or cleaning agents, in particular soda and/or percarbonates, may be contained in or on the molded foam body.

Preferably, the molded foam body according to the invention can be aftertreated or powdered with solids, preferably in quantities up to 15% by weight, in particular in quantities of from 2 to 15% by weight, in each case based on the total weight of the aftertreated or powdered molded foam body.

As solids for the aftertreatment or powdering, use may preferably be made of bicarbonate, carbonate, percarbonate, zeolite, silica, citrate, urea or mixtures thereof, in particular in quantities of from 2 to 15% by weight, based on the total weight of the aftertreated molded foam body. The aftertreatment can advantageously be carried out in a mixer and/or by rounding machines.

In further embodiments of the molded foam body, the liquid washing or cleaning agent composition contains less than 10% by weight, preferably less than 5% by weight, of water, based on the total weight of the liquid washing or cleaning agent composition. This ensures that the molded foam body does not dissolve or disintegrate during storage due to the liquid washing or cleaning agent contained therein. Preferably, the water content is less than 10, 9, 8, 7, 6, 5, 4, 3, 2, 1, 0.1% by weight water, based on the total weight of the liquid washing or cleaning agent composition.

In different embodiments of the liquid washing or cleaning agent, the agent includes at least one constituent selected from the group consisting of a surfactant, plasticizer, perfume, perfume delivery system, colorant, preservative, bittering agent, filler, auxiliary, special polymer and a functional additive.

In certain embodiments, the term special polymers encompasses greying inhibitors, dirt-repelling polymers and dirt-suspending polymers.

In certain embodiments of the present invention, the term surfactant will be understood to mean a cleaning surfactant, that is to say a surfactant which actively removes soil from soiled textiles.

In different embodiments, the liquid washing or cleaning agent includes a single surfactant. In some embodiments, the foam contains at least one surfactant. In different embodiments, the surfactant will be selected in particular from the group consisting of non-ionic, cationic, anionic, amphoteric surfactants and mixtures thereof. Also suitable are all surfactants which are disclosed in connection with the unit doses of liquid and solid washing agents. In different embodiments, the proportion of surfactant in the foam is at least 0.1% by weight. Preferably, the proportion of surfactant is 1% by weight or more, 5% by weight or more, 10% by weight or more, 15% by weight or more, 20% by weight or more or 25% by weight or more. In different embodiments, the foam contains up to 75% by weight, up to 70% by weight, up to 60% by weight, up to 50% by weight, up to 40% by weight or up to 30% by weight surfactant. In particular, the dry foam may also contain surfactant, for example 1 to 50% by weight or 10 to 40% by weight surfactant.

With particular preference, the liquid washing or cleaning agent contains an anionic surfactant. Any anionic surfactants disclosed herein are suitable. Alk(en)yl sulphates, preferably the alkali metal salts and in particular the sodium salts of the sulphuric acid half-ester of C12-C18 fatty alcohols, for example from coconut fatty alcohol, tallow fatty alcohol, lauryl, myristyl, cetyl or stearyl alcohol or the C10-C20 oxo alcohols and those half-esters of secondary alcohols of these chain lengths are particularly suitable with preference. For technical reasons relating to washing, preference is given to the C12-C16 alkyl sulphates and C12-C15 alkyl sulphates, as well as C14-C15 alkyl sulphates. Secondary and tertiary alkyl sulphates are also suitable anionic surfactants.

As the anionic surfactant, use may preferably be made of sulphonates and/or sulphates. The anionic surfactant content is 5 to 25% by weight and preferably 8 to 20% by weight, in each case based on the total washing or cleaning agent.

As surfactants of the sulphonate type, consideration is preferably given here to C9-13 alkylbenzene sulphonates, olefin sulphonates, that is to say mixtures of alkene and hydroxyalkane sulphonates and disulphonates, as obtained for example from C12-18 monoolefins with a terminal or internal double bond by sulphonating with gaseous sulphur trioxide and subsequent alkaline or acid hydrolysis of the sulphonation products. Also suitable are C12-18 alkane sulphonates and the esters of α-sulpho fatty acids (ester sulphonates), for example the α-sulphonated methyl esters of hydrogenated coconut fatty acid, palm kernel fatty acid or tallow fatty acid.

As alk(en)yl sulphates, preference is given to the alkali metal salts and in particular the sodium salts of the sulphuric acid half-esters of C12-C18 fatty alcohols, for example from coconut fatty alcohol, tallow fatty alcohol, lauryl, myristyl, cetyl or stearyl alcohol or the C10-C20 oxo alcohols and those half-esters of secondary alcohols of these chain lengths. For technical reasons relating to washing, preference is given to the C12-C16 alkyl sulphates and C12-C15 alkyl sulphates, as well as C14-C15 alkyl sulphates. Secondary and tertiary alkyl sulphates are also suitable anionic surfactants.

Also suitable are fatty alcohol ether sulphates, such as the sulphuric acid monoesters of linear or branched C7-21 alcohols ethoxylated with 1 to 6 mol ethylene oxide, such as 2-methyl-branched C9-11 alcohols having on average 3.5 mol ethylene oxide (EO) or C12-18 fatty alcohols having 1 to 4 EO. The anionic surfactant is preferably sodium lauryl ether sulphate (Texapon N70).

Other suitable anionic surfactants are soaps. Saturated and unsaturated fatty acid soaps are suitable, such as the salts of lauric acid, myristic acid, palmitic acid, stearic acid, (hydrogenated) erucic acid and behenic acid, as well as in particular soap mixtures derived from natural fatty acids, for example coconut fatty acid, palm kernel fatty acid, olive oil fatty acid or tallow fatty acid.

The anionic surfactants and the soaps may be present in the form of their sodium, potassium, magnesium or ammonium salts. Preferably, the anionic surfactants are present in the form of their ammonium salts. Preferred counter-ions for the anionic surfactants are the protonated forms of choline, triethylamine, monoethanolamine or methylethylamine.

Suitable non-ionic surfactants include alkoxylated fatty alcohols, alkoxylated fatty acid alkyl esters, fatty acid amides, alkoxylated fatty acid amides, polyhydroxy fatty acid amides, alkylphenol polyglycol ethers, amine oxides, alkyl polyglucosides, hydroxy mixed ethers and mixtures thereof.

As the non-ionic surfactant, use is preferably made of alkoxylated, advantageously ethoxylated, in particular primary alcohols with preferably 8 to 18 C atoms and on average 4 to 12 mol ethylene oxide (EO) per mole of alcohol, in which the alcohol residue may be linear or may preferably be methyl-branched in the 2-position and/or may contain linear and methyl-branched residues in the mixture, such as those usually present in oxo alcohol residues. In particular, however, preference is given to alcohol ethoxylates with linear residues of alcohols of native origin having 12 to 18 C atoms, for example from coconut alcohol, palm alcohol, tallow fatty alcohol or oleyl alcohol, and on average 5 to 8 EO per mole of alcohol. The preferred ethoxylated alcohols include for example C12-14 alcohols with 4 EO or 7 EO, C9-11 alcohol with 7 EO, C13-15 alcohols with 5 EO, 7 EO or 8 EO, C12-18 alcohols with 5 EO or 7 EO, and mixtures thereof. The specified degrees of ethoxylation are statistical averages which may be an integer or a fractional number for a specific product. Preferred alcohol ethoxylates have a narrowed homologue distribution (narrow range ethoxylates, NREs). In addition to these non-ionic surfactants, fatty alcohols with more than 12 EO may also be used. Examples of these include tallow fatty alcohol with 14 EO, 25 EO, 30 EO or 40 EO. Non-ionic surfactants which contain EO and PO groups together in the molecule can also be used according to the invention. Furthermore, a mixture of a (more strongly) branched ethoxylated fatty alcohol and an unbranched ethoxylated fatty alcohol, such as for example a mixture of a C16-18 fatty alcohol with 7 EO and 2-propylheptanol with 7 EO, is also suitable. In particular, the washing agent, cleaning agent, aftertreatment agent or washing aid preferably contains as the non-ionic surfactant a C12-18 fatty alcohol with 7 EO or a C13-15 oxo alcohol with 7 EO.

Further suitable non-ionic surfactants are selected from the group consisting of polyethoxylated alkylphenols, polyethoxylated alcohols, polyethoxylated polyoxypropylene glycols, glycerol esters of alkanoic acids, polyglycerol esters of alkanoic acids, propylene glycol esters of alkanoic acids, sorbitan esters of alkanoic acids, polyethoxylated sorbitan esters of alkanoic acids, polyethoxylated glycol esters of alkanoic acids, polyethoxylated alkanoic acids, alkanolamides, N-alkylpyrrolidones, alkyl glycosides, alkyl polyglucosides, alkylamine oxides and polyethoxylated silicones.

Further suitable surfactants are selected from the group consisting of block copolymers of ethylene oxide and fatty alkyl residues, block copolymers of ethylene oxide and propylene oxide, hydrophobically modified polyacrylates, hydrophobically modified celluloses, silicone polyethers, silicone copolyol esters, diquaternary polydimethylsiloxanes and co-modified amino/polyether silicones.

The non-ionic surfactant content is 1 to 25% by weight and preferably 2 to 20% by weight, in each case based on the total liquid washing or cleaning agent.

The total amount of anionic and non-ionic surfactant in the liquid washing or cleaning agent of the unit dose is up to 50% by weight, preferably up to 45% by weight, based on the total liquid washing or cleaning agent.

In some embodiments, the plasticizer is selected from the group consisting of glycerol and polyols.

In certain embodiments, the auxiliary is selected from the group consisting of thickeners and salts.

Suitable thickeners are for example those from the group of natural polymers, for example agar-agar, carrageenan, tragacanth, gum arabic, alginates, pectins, polyoses, guar flour, locust bean gum, starch, dextrins, gelatin and casein. Thickeners which are modified natural substances come primarily from the group consisting of modified starches and celluloses; by way of example, mention may be made here of carboxymethyl cellulose and other cellulose ethers, hydroxyethyl and hydroxypropyl cellulose and also carob bean flour ether. Microfibrillar bacterial celluloses are also suitable as thickeners. The fully synthetic polymers, such as polyacrylic and polymethacrylic compounds, vinyl polymers, polycarboxylic acids, polyethers, polyimines, polyamides and polyurethanes, are a large group of thickening agents which are widely used in many different fields of application. Xanthan gum is also suitable and preferred.

In some embodiments, the special polymer is selected from the group consisting of acrylic acid (co)polymer, cationic hydroxymethyl cellulose, carboxymethyl cellulose and HPMC.

In other embodiments, the functional additive is selected from the group consisting of silicone oils, bentonites, perfume capsules, perfume delivery systems, enzymes and bleach.

Preferably, the bleach is selected from the group consisting of peroxy acids and amides of various peroxy acids, for example phthalimidoperoxyhexanoic acid (PAP). Alternatively, the bleach may be C8 or C9 acid in combination with H₂O₂. To this end, an at least slightly acidic pH is set.

In further embodiments of the washing or cleaning agent article, the water-soluble polyvinyl alcohol and/or polyvinylpyrrolidone and/or copolymer of the substantially dry, substantially water-soluble foam of the first flexible, substantially water-soluble layer has an average chain length of 600 to 12,000, in particular 1000 to 8000.

In certain embodiments of the washing or cleaning agent article, the water-soluble polyvinyl alcohol and/or polyvinylpyrrolidone and/or copolymer of the second substantially water-soluble layer has an average chain length of 600 to 12,000, in particular 1000 to 8000. In particular embodiments, the substantially water-soluble film of the at least one second substantially water-soluble layer has an average chain length of 600 to 12,000, in particular 1000 to 8000.

In further embodiments, both the water-soluble polyvinyl alcohol and/or polyvinylpyrrolidone and/or copolymer of the flexible, substantially dry, substantially water-soluble foam layer of the at least one first layer and also the water-soluble polyvinyl alcohol and/or polyvinylpyrrolidone and/or copolymer of the at least one second substantially water-soluble layer, in particular the substantially water-soluble film of the substantially water-soluble at least one second layer, have an average chain length of 600 to 12,000, in particular 1000 to 8000.

The term “average chain length” refers to the average number of monomer units in the backbone of a polymer chain within a population of polymer chains. The average chain length of a polymer is determined by means of gel permeation chromatography (GPC), use being made of a UV detector. Suitable reference compositions/compounds are used for calibration.

In different embodiments of the molded foam body, the boric acid content is up to 0.5% by weight, in particular up to 0.1% by weight, very particularly preferably 0% by weight, based on the total weight of the washing or cleaning agent composition, preferably based on the total weight of the molded foam body. Boric acid is a typical reversible protease inhibitor which, when a washing or cleaning agent is diluted in the washing liquor, detaches from the protease on account of the kinetic properties and thus enables the proteolytic activity of the protease. This inhibitor prevents the autoproteolysis of the protease during storage, and in particular the proteolytic digestion of other enzymes in the washing or cleaning agent. However, boric acid is subject to criticism due to environmental considerations and the risk to health. Since the present invention provides a molded foam body which enables a spatial separation of individual constituents of the washing or cleaning agent, be this within a single molded foam body or by distributing the components among different molded foam bodies, the quantity of boric acid can be considerably reduced. In particular embodiments, therefore, the molded foam body is free of boric acid.

The content of one or more enzyme preparations in the liquid washing or cleaning agent lies preferably in a range from 0 to 10% by weight, particularly preferably in a range from 0.1 to 7.5% by weight, based on the total weight of the washing or cleaning agent, preferably based on the weight of the molded foam body.

An enzyme preparation is a composition which, in addition to 1-15% by weight pure active enzyme(s), usually comprises water and stabilizers.

The term enzyme, as used here, preferably encompasses hydrolytic enzymes. These are in particular proteases, amylases, (in particular a-amylases), cellulases, lipases, hemicellulases (in particular pectinases, mannanases, β-glucanases), and mixtures thereof. The hydrolytic enzyme is particularly preferably selected from at least one protease, amylase or lipase and mixtures thereof, and very particularly preferably from at least one protease and/or at least one amylase. Most preferably, the liquid washing or cleaning agent according to the invention contains as hydrolytic enzyme at least one protease and at least one amylase. These enzymes are in principle of natural origin. Improved variants stemming from the natural molecules are available for use in washing or cleaning agents, and these are used with preference.

A protease is an enzyme which cleaves peptide bonds by means of hydrolysis. Each of the enzymes of Class E.C. 3.4 falls thereunder according to the invention (including each of the thirteen sub-classes therein). The EC number corresponds to the NC-IUBMB enzyme nomenclature.

Subtilases is the name used for one sub-group of serine proteases. The serine proteases or serine peptidases are a sub-group of the proteases having serine in the active center of the enzyme, which forms a covalent adduct with the substrate. Furthermore, the subtilases (and the serine proteases) are characterized in that they have, alongside said serine, with histidine and aspartame, two further amino acid residues in the active center. The subtilases can be into 6 sub-classes, namely the subtilisin family, the thermitase family, the proteinase K family, the lantibiotic peptidase family, the kexin family and the pyrrolysine family. The proteases preferably contained as a constituent of the compositions according to the invention are endopeptidases (EC 3.4.21).

According to the invention, “protease activity” exists when the enzyme has proteolytic activity (EC 3.4). Various types of protease activity are known. The three main types are: trypsin-like, wherein a cleavage of the amide substrate takes place after the amino acids Arg or Lys at P1; chymotryp sin-like, wherein a cleavage takes place after one of the hydrophobic amino acids at P1; and elastase-like, wherein a cleavage of the amide substrate takes place after Ala at P1.

The protease activity can be determined by the method described in Tenside, Vol. 7 (1970), pages 125-132. It is accordingly specified in PE (protease units). The protease activity of an enzyme can be according to customary standard methods, such as in particular using BSA as substrate (bovine albumin) and/or using the AAPF method.

Among the proteases, preference is given to those of the subtilisin type. Examples of these are subtilisin BPN' and Carlsberg, protease PB92, subtilisins 147 and 309, the alkaline protease from Bacillus lentus, subtilisin DY, and the enzymes thermitase and proteinase K which can be assigned to the subtilases but no longer to the subtilisins in the narrower sense, and the proteases TW3 and TW7. Subtilisin Carlsberg is available in a further developed form under the trade name Alcalase® from the company Novozymes A/S, Bagsvaerd, Denmark. Subtilisins 147 and 309 are sold under the trade names Esperase® and Savinase®, respectively, by the company Novozymes. Derived from the protease of Bacillus lentus DSM 5483 are the protease variants marketed under the name BLAP®. Other proteases which can be used are for example the enzymes available under the trade names Durazym®, Relase®, Everlase®, Nafizym®, Natalase®, Kannase® and Ovozyme® from the company Novozymes, the enzymes available under the trade names Purafect®, Purafect® OxP, Purafect® Prime, Excellase® and Propera-se® from the company Genencor, the enzyme available under the trade name Protosol® from the company Advanced Biochemicals Ltd., Thane, India, the enzyme available under the trade name Wuxi® from the company Wuxi Snyder Bioproducts Ltd., China, the enzymes available under the trade names Proleather® and Protease P® from the company Amano Pharmaceuticals Ltd., Nagoya, Japan, and the enzyme available under the name Proteinase K-16 from the company Kao Corp., Tokyo, Japan. The proteases from Bacillus gibsonii and Bacillus pumilus, which are disclosed in international patent applications WO 2008/086916 and WO 2007/131656, are also used with particular preference.

The liquid washing or cleaning agents according to the invention contain as the hydrolytic enzyme preferably at least one α-amylase. As an enzyme, a-amylases (E.C. 3.2.1.1) hydrolyze internal α-1,4-glycosidic bonds of starch and starch-like polymers. This α-amylase activity is measured for example in KNU (Kilo Novo Units) according to applications WO 97/03160 A1 and GB 1296839. Here, 1 KNU represents the amount of enzyme which hydrolyzes 5.25 g of starch (available from the company Merck, Darmstadt, Germany) per hour at 37° C., pH 5.6 and in the presence of 0.0043 M calcium ions. An alternative activity determination method is the so-called DNS method, which is described for example in application WO 02/10356 A2. According to this method, the oligosaccharides, disaccharides and glucose units released by the enzyme during the hydrolysis of starch are detected by oxidizing the reducing ends using dinitrosalicylic acid (DNS). The activity is obtained in μmol of reducing sugars (based on maltose) per min and mL; activity values in TAU are thus obtained. The same enzyme can be determined via different methods, wherein the respective conversion factors may vary depending on the enzyme and thus must be defined with reference to a standard. Approximately, it can be calculated that 1 KNU corresponds to approximately 50 TAU. A further activity determination method is by measurement using the Quick-Start test kit from the company Abbott, Abott Park, Ill., USA.

The preferred field of use according to the invention for the molded foam bodies according to the invention is in the cleaning of textiles. Because washing and cleaning agents for textiles predominantly have alkaline pH values, use is made in particular of a-amylases which are active in alkaline medium. These are produced and secreted by microorganisms, that is to say fungi or bacteria, especially those of the genera Aspergillus and Bacillus. Proceeding from these natural enzymes, an almost incalculable number of variants are also available, which have been derived via mutagenesis and have specific advantages depending on the field of use.

Examples of amylases which can be used according to the invention are the α-amylases from Bacillus licheniformis, from B. amyloliquefaciens or from B. stearothermophilus, as well as the further developments thereof improved for use in washing or cleaning agents. The enzyme from B. licheniformis is available from the company Novozymes under the name Termamyl® and from the company Genencor under the name Purastar®ST. Further-developed products of these α-amylases are available from the company Novozymes under the trade names Duramyl® and Termamyl®ultra, from the company Genencor under the name Purastar®OxAm and from the company Daiwa Seiko Inc., Tokyo, Japan, as Keistase®. The α-amylase from B. amyloliquefaciens is sold by the company Novozymes under the name BAN®, and derived variants of the α-amylase from B. stearothermophilus under the names BSG® and Novamyl®, again from the company Novozymes. Also to be highlighted for this purpose are the α-amylase from Bacillus sp. A 7-7 (DSM 12368) and the cyclodextrin glucanotransferase (CGTase) from B. agaradherens (DSM 9948). It is also possible to use the amylolytic enzymes which belong to the sequence space of α-amylases, the latter being defined in international patent application WO 03/002711 A2, and which are described in application WO 03/054177 A2. Fusion products of said molecules can also be used. The further developments of the α-amylase from Aspergillus niger and A. oryzae, available under the trade name Fungamyl® from the company Novozymes, are also suitable.

Other commercial products which can be used with preference are selected from Amylase-LT®, Stainzyme®, Stainzyme ultra®, Stainzyme plus® (the latter likewise from the company Novozymes) or mixtures thereof. Variations of these enzymes obtainable by point mutations can also be used according to the invention.

An agent according to the invention which contains as the hydrolytic enzyme at least one serine protease as the protease and at least one a-amylase as the amylase has proven to be very particularly preferred.

The compositions according to the invention may preferably contain at least one lipase as the hydrolytic enzyme. A lipase contained in the washing and cleaning agents according to the invention has a lipolytic activity, that is to say it is suitable for the hydrolysis (lipolysis) of lipids such as glycerides or cholesterol esters. This lipase activity is determined in a routine manner, namely preferably as described in Bruno Stellmach, “Bestimmungsmethoden Enzyme für Pharmazie, Lebensmittelchemie, Technik, Biochemie, Biologie, Medizin” (Steinkopff Verlag Darmstadt, 1988, page 172 ff). Therein, lipase-containing samples are added to an olive oil emulsion in emulsifier-containing water and are incubated at 30° C. and pH 9.0. During this, fatty acids are released. The latter are continuously titrated using an autotitrator for 20 min with 0.01 N sodium hydroxide, so that the pH value remains constant (“pH-stat titration”). The lipase activity is determined on the basis of the sodium hydroxide consumption, with reference to a reference lipase sample. Another suitable method for measuring lipase activity is the release of a dye from a suitable pNP-labelled substrate.

Lipase enzymes which are preferred according to the invention are selected from at least one enzyme from the group formed by triacylglycerol lipase (E.C. 3.1.1.3) and lipoprotein lipase (E.C. 3.1.1.34) and monoglyceride lipase (E.C. 3.1.1.23).

Examples of lipases or cutinases which can be used according to the invention and which are contained in particular due to their triglyceride-cleaving activities but also to produce peracids in situ from suitable precursors are the lipases obtainable originally from Humicola lanuginosa (Thermomyces lanuginosus) or further-developed lipases, in particular those having the D96L amino acid exchange. They are sold for example by the company Novozymes under the trade names Lipolase®, Lipolase® Ultra, LipoPrime®, Lipozyme® and Lipex®. It is also possible to use for example the cutinases originally isolated from Fusarium solani pisi and Humicola insolens. Lipases which can also be used are available from the company Amano under the names Lipase CE®, Lipase P®, Lipase B®, or Lipase CES®, Lipase AKG®, Bacillis sp. Lipase®, Lipase AP®, Lipase M-AP® and Lipase AML®. From the company Genencor, it is possible to use for example the lipases and cutinases whose starting enzymes were originally isolated from Pseudomonas mendocina and Fusarium solanii. As further important commercial products, mention is made of the preparations M1 Lipase® and Lipomax® originally sold by the company Gist-Brocades, and of the enzymes sold by the company Meito Sangyo KK, Japan, under the names Lipase MY-30®, Lipase OF® and Lipase PL®, and also of the product Lumafast® from the company Genencor.

A highly preferred lipase is available commercially under the trade name Lipex® from the company Novozymes (Denmark) and this can be used with advantage in the cleaning compositions according to the invention. Here, particular preference is given to the lipase Lipex® 100 L (from Novozymes A/S, Denmark).

As the hydrolytic enzyme, use may also be made of those which are grouped under the term hemicellulases. These include for example mannanases, xanthanlyases, pectinlyases (=pectinases), pectinesterases, pectatelyases, xyloglucanases (=xylanases), pullulanases, and β-glucanases. Enzymes suitable in this regard are available for example under the names Gamanase® and Pektinex AR® from the company Novozymes, under the name Rohapec® B1L from the company AB Enzymes, and under the name Pyrolase® from the company Diversa Corp., San Diego, Calif., USA. The β-glucanase obtained from Bacillus subtilis is available under the name Cereflo® from the company Novozymes. Hemicellulases which are particularly preferred according to the invention are mannanases, which are sold for example under the trade names Mannaway® by the company Novozymes or Purabrite® from the company Genencor.

In the context of the invention, the enzymes can also be formulated together with accompanying substances, for instance from the fermentation, or with stabilizers.

Based on the weight of the agent, the liquid washing or cleaning agent contains hydrolytic enzymes preferably in a total quantity of from 1×10⁻⁸ to 5% by weight based on active protein. Preferably, based on the weight of the agent, the enzymes are contained in said agents in a total quantity of from 0.001 to 5% by weight, more preferably from 0.01 to 5% by weight, even more preferably from 0.05 to 4% by weight, and particularly preferably from 0.075 to 3.5% by weight.

The protein concentration can be determined using known methods, for example the BCA method (bicinchoninic acid; 2,2′-biquinolyl-4,4′-dicarboxylic acid) or the biuret method (A. G. Gornall, C. S. Bardawill and M. M. David, J. Biol. Chem., 177 (1948), pages 751-766).

In a further embodiment, the molded foam body is characterized in that the dry foam of the molded foam body includes at least one first and at least one second liquid washing or cleaning agent composition, wherein the at least one first and the at least one second liquid washing or cleaning agent composition are spatially separate from one another.

Preferably, the at least one first and the at least one second liquid washing or cleaning agent composition differ in terms of the concentration of at least one constituent. Preferably, the at least one constituent is contained in the first liquid washing or cleaning agent composition and is absent in the second liquid washing or cleaning agent composition and the at least one constituent is incompatible with at least one constituent of the second liquid washing or cleaning agent composition.

The term “incompatible” means that one constituent of the washing or cleaning agent, during the usual storage of the molded foam body prior to use, ensures that another constituent decreases or at least demonstrably and significantly loses its later effect in the washing or cleaning process.

This constituent may mean for example a protease which, without an inhibitor, is incompatible with other enzymes since it proteolytically digests and thus inactivates said enzymes. The term constituent may also mean bleach which inactivates other washing or cleaning agents, such as enzymes for example, during storage.

In some embodiments of the molded foam body, the at least one first liquid washing or cleaning agent composition contains at least one protease and the at least one second liquid washing or cleaning agent composition includes enzymes selected from the group consisting of mannanase, cellulases, amylases, lipases, hemicellulases and mixtures thereof and contains 0% by weight protease based on the total weight of the at least one second liquid washing or cleaning agent composition.

In certain embodiments of the molded foam body, the at least one first liquid washing or cleaning agent composition contains at least one bleaching agent and the at least one second liquid washing or cleaning agent composition includes enzymes and contains 0% by weight bleaching agents based on the total weight of the at least one second liquid washing or cleaning agent composition.

In another aspect, the present invention relates to a set consisting of at least two molded foam bodies, as described herein, characterized in that the set comprises at least one first and at least one second molded foam body, wherein the dry foam of the at least one first molded foam body includes a liquid washing or cleaning agent composition which contains at least one first constituent, the concentration of which in the liquid washing or cleaning agent composition of the at least one first molded foam body is higher than in the liquid washing or cleaning agent composition that is located in the dry foam of the at least one second molded foam body, wherein preferably the at least one first constituent is incompatible with a constituent which is contained in the liquid washing or cleaning agent composition that is located in the dry foam of the at least one second molded foam body.

In the context of the present invention, a set of molded foam bodies may include 2, 3, 4, 5, 6, 7, 8, 9, 10, 11, 12, 13, 14, 15, 16, 17, 18, 19, 20, 21, 22, 23, 24, 25, 1-25, 1-30, 1-40, 1-50, 1-60 or more molded foam bodies. In certain embodiments, a set consists of precisely as many molded foam bodies as necessary to achieve an active washing liquor after dissolution and/or disintegration in water. In other embodiments, a set of molded foam bodies includes as many molded foam bodies as the consumer usually requires for 1-5, 1-10, 1-20, 1-30, 1-50, 1-70 or 1-100 washing or cleaning cycles.

In certain embodiments, the set according to the invention is characterized in that the liquid washing or cleaning agent composition of the at least one first molded foam body includes at least one protease and the liquid washing or cleaning agent composition of the at least one second molded foam body includes enzymes selected from the group consisting of cellulases, mannanases, hemicellulases, amylases and lipases and mixtures thereof.

In different embodiments, the set according to the invention is characterized in that the liquid washing or cleaning agent composition of the at least one first molded foam body includes bleaching agents and the liquid washing or cleaning agent composition of the at least one second molded foam body includes enzymes, wherein preferably the at least one first molded foam body comprises less than 0.1% by weight water, based on the total weight of the at least one first molded foam body.

In a further aspect, the present invention relates to a method for producing a molded foam body, as described herein, characterized in that an unfilled molded foam body is provided which comprises dry foam consisting of cells, and cells of the dry foam are filled with at least one first liquid washing or cleaning agent composition, wherein preferably the filling takes place by injection, vacuum filling or compression with subsequent release, particularly preferably by means of injection.

The foam may be produced by customary methods, such as extrusion for example. In this connection, reference is made to publication EP 1534811 B 1, the disclosure of which is incorporated herein by way of reference with regard to the extrusion method and shaping of foam bodies.

The term may mean any type of injection. For example, the injection into the dry foam may take place using a customary syringe, which is filled with a washing or cleaning agent composition, through a cannula connected to the syringe. In this case, the liquid washing or cleaning agent composition remains storage-stable in the cells of the foam. This may be achieved in particular through the consistency of the liquid and the ratio of open to closed cells of the dry foam in the molded foam body.

The liquid washing or cleaning agent may likewise be introduced into the dry foam of the molded foam body by means of vacuum filling.

As an alternative, the dry foam of the molded foam body may be compressed in order to allow any air or liquid contained in the foam to escape. The foam may then be released in the presence of liquid washing or cleaning agent so that the liquid is taken up into the sponge.

Usually, 50% of the cells of the dry foam are closed cells; in some embodiments, the dry foam comprises more than 70% open cells, preferably more than 80% open cells.

In some embodiments, the method is characterized in that cells of the dry foam of the molded foam body are filled with at least two liquid washing or cleaning agent compositions by means of injection, wherein the injection takes place in such a way that the at least one first and the at least one second liquid washing or cleaning agent composition are spatially separate from one another in the foam of the molded foam body, wherein preferably the at least one first and the at least one second liquid washing or cleaning agent composition differ in terms of the concentration of at least one constituent, wherein preferably the at least one constituent is contained in the first liquid washing or cleaning agent composition and is incompatible with at least one constituent of the second liquid washing or cleaning agent composition.

In further embodiments, the method is characterized in that the at least one first liquid washing or cleaning agent composition is produced in the molded foam body by at least two injections into the cells of the dry foam of the molded foam body, wherein preferably the at least one first liquid washing or cleaning agent composition in the dry foam of the molded foam body contains at least one alkylbenzene sulphonate and the method comprises a first injection of the corresponding acid and a second injection of the corresponding neutralizing agent so that the at least one first liquid washing or cleaning agent composition, which includes at least one alkylbenzene sulphonate, is produced in the dry foam of the foam body.

In a further aspect, the invention comprises a washing or cleaning method comprising the method steps:
i) providing a washing or cleaning solution comprising one or more molded foam bodies, as described herein, or one or more sets, as described herein,
ii) bringing a soiled object, preferably a soiled textile, in particular a soiled flat textile, or a soiled hard surface, in particular a soiled dish, into contact with the washing or cleaning solution according to (i).

Preferably, the method is carried out in a washing machine or an automatic dishwasher.

A further aspect relates to the use of a molded foam body, as described herein, or of a set, as described herein, for washing textiles or for cleaning hard surfaces. In particular, the method is suitable for removing soil on textiles or hard surfaces. Preferably, the molded foam body or the set is suitable for use in a washing machine or an automatic dishwasher.

### EXAMPLES

In the following particulars, the stated quantity of a component refers to the total quantity that has been distributed among the stated number of peanut flips by injection.

11 grams of liquid mannanase preparation Mannaway 4.0 L were injected into 23 commercially available peanut flips of the ErdnuB Locken Classic brand from the company Lorenz. 11.7 grams of liquid cellulose preparation Ecostone N400 were injected into 21 peanut flips, 9.5 grams of liquid protease preparation PUR225 were injected into 23 peanut flips, and 9.6 grams of liquid amylase preparation Stainzyme were injected into 22 peanut flips.

The fatty acid PK 12-18 GA was incorporated in a quantity of 6 grams distributed among 23 flips per injection.

5.91 grams of LAS acid were incorporated in 21 peanut flips per injection. The peanut flips were powdered in soda.

The following constituents were also injected into the stated quantity of peanut flips:

| | |
|---|---|
| 7.1 grams of Dehydrol LT7 | into 22 peanut flips |
| 6.4 grams of perfume oil Stardust | into 22 peanut flips |
| 11.9 grams of Texapon NSO | into 21 peanut flips |
| 7.7 grams of Texacare SRN 170 | into 22 peanut flips |
| 3.2 grams of liquid lipase preparation Lipex | into 8 peanut flips |
| 3.2 grams of cellulose preparation Renozyme 4500L | into 8 peanut flips |
| 3.6 grams of sodium lauryl sulphate Sulfopon K35 | into 8 peanut flips |
| 4.75 grams of phosphonate Dequest 2066 | into 11 peanut flips |

This set of peanut flips represents an example of a new administration form for the cleaning or washing agent composition. The consumer does not come into contact with the liquid cleaning or washing agent contained therein. The peanut flips thus filled can be used in a commercially available washing machine for washing laundry. The washing result is comparable to that of conventional liquid washing agents. The washing or cleaning agent contained in the peanut flips is released when the flip comes into contact with water. The material of the foam (peanut flips) dissolves upon contact with water or is finely dispersed after disintegrating. The same observations are made when used in an automatic dishwasher.

The features of the invention which are disclosed in the present description and in the claims may be essential both individually and in any combinations for implementing the invention in its various embodiments. The invention is not limited to the described embodiments. It can be varied within the scope of the claims and by taking account of the knowledge of the relevant person skilled in the art.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A molded foam body, wherein
a. the molded foam body comprises dry foam consisting of cells, wherein the material from which the walls of the foam cells are formed comprises one or more polysaccharides or foam sugars in a proportion of at least 10% by weight, based on the total weight of the material from which the cell walls of the dry foam are formed,
b. the molded foam body contains a liquid washing or cleaning agent composition in a proportion of at least 5% by weight, based on the total weight of the molded foam body, and
c. the liquid washing or cleaning agent composition is arranged within the cells of the dry foam of the molded foam body and, when the molded foam body comes into contact with water, the liquid washing or cleaning agent composition is released into the water, and
wherein the material of the dry foam, can disintegrate in water and/or is water-soluble.

2. The molded foam body according to claim 1, wherein:
i) the density of the molded foam body filled with the liquid washing or cleaning agent composition lies in a range from 0.7 to 0.9 g/mL; and/or
ii) the dry foam of the molded foam body has a layer which extends over the entire outer side of the dry foam and comprises at least the outermost 2 mm of the dry foam of the molded foam body and is not filled with the liquid washing or cleaning agent composition; and/or
iii) the molded foam body contains at least 100% by weight, of liquid washing or cleaning agent composition based on the weight of the dry foam,; and/or
iv) the liquid washing or cleaning agent composition comprises 0.01 to 90% by weight, of at least one alkylbenzene sulphonate, 0 to 10% by weight, of at least one enzyme, 0 to 90% by weight, of at least one non-ionic surfactant, 0 to 90% by weight, of fatty acid, 0 to 90% by weight, of bleaching agents and bleach activators, 0 to 90% by weight, of polymers and perfume oils and/or 0 to 90% by weight, of builder polymers, based on the total weight of the respective washing or cleaning agent composition; and/or
v) the liquid washing or cleaning agent composition contains less than 10% by weight, of water, based on the total weight of the liquid washing or cleaning agent composition; and/or
vi) the boric acid content is up to 0.5% by weight, based on the total weight of the washing or cleaning agent composition.

3. The molded foam body according to claim 1, wherein the dry foam of the molded foam body comprises at least one first and at least one second liquid washing or cleaning agent composition, wherein the at least one first and the at least one second liquid washing or cleaning agent composition are spatially separate from one another, wherein the at least one first and the at least one second liquid washing or cleaning agent composition differ in terms of the concentration of at least one constituent, wherein the at least one constituent is contained in the first liquid washing or cleaning agent composition and is absent in the second liquid washing or cleaning agent composition and the at least one constituent is incompatible with at least one constituent of the second liquid washing or cleaning agent composition

4. A set consisting of at least two molded foam bodies according to claim 1, wherein the set comprises at least one first and at least one second molded foam body, wherein the dry foam of the at least one first molded foam body comprises a liquid washing or cleaning agent composition which comprises at least one first constituent, the concentration of which in the liquid washing or cleaning agent composition of the at least one first molded foam body is higher than in the liquid washing or cleaning agent composition that is located in the dry foam of the at least one second molded foam body.

5. A set according to claim 4, wherein
a) the liquid washing or cleaning agent composition of the at least one first molded foam body includes at least one protease and the liquid washing or cleaning agent composition of the at least one second molded foam body includes enzymes selected from the group consisting of cellulases, mannanases, hemicellulases, amylases and lipases and mixtures thereof; and/or
b) the liquid washing or cleaning agent composition of the at least one first molded foam body includes bleaching agents and the liquid washing or cleaning agent composition of the at least one second molded foam body includes enzymes, wherein the at least one first molded foam body comprises less than 0.1% by weight water, based on the total weight of the at least one first molded foam body.

6. A method for producing a molded foam body according to claim 1, subsequent release.

7. The method according to claim 6, wherein cells of the dry foam of the molded foam body are filled with at least two liquid washing or cleaning agent compositions by means of injection, wherein the injection takes place in such a way that the at least one first and the at least one second liquid washing or cleaning agent composition are spatially separate from one another in the foam of the molded foam body, wherein the at least one first and the at least one second liquid washing or cleaning agent composition differ in terms of the concentration of at least one constituent.

8. The method according to claim 6, wherein the at least one first liquid washing or cleaning agent composition is produced in the molded foam body by at least two injections into the cells of the dry foam of the molded foam body, wherein the at least one first liquid washing or cleaning agent composition in the dry foam of the molded foam body contains at least one alkylbenzene sulphonate and the method comprises a first injection of the corresponding acid and a second injection of the corresponding neutralizing agent so that the at least one first liquid washing or cleaning agent composition, which includes at least one alkylbenzene sulphonate, is produced in the dry foam of the foam body.

9. A washing or cleaning method comprising the method steps:
iii) providing a washing or cleaning solution comprising one or more molded foam bodies according to claim 1,
iv) bringing a soiled a soiled textile, into contact with the washing or cleaning solution according to (i), wherein the method is carried out in a washing machine or an automatic dishwasher.
